(19) United States
(12) Patent Application Publication
(10) Pub. No.: US 2025/0348770 A1
(43) Pub. Date: Nov. 13, 2025

(54) Implementing Quantum Logic Gates using Pulse Analysis for Quantum Computing System

(71) Applicant: Google LLC, Mountain View, CA (US)

(72) Inventors: Zhang JIANG, El Segundo, CA (US); Wojtek Jerzy MRUCZKIEWICZ, Zürich (CH); Dripto Mazumdar DEBROY, Los Angeles, CA (US); Jonathan Arthur GROSS, Venice, CA (US); Élie GENOIS, Sherbrooke, Quebec (CA)

(21) Appl. No.: 18/593,564

(22) Filed: Mar. 1, 2024

Related U.S. Application Data
(60) Provisional application No. 63/488,290, filed on Mar. 3, 2023.

(51) Int. Cl. G06N 10/40

(52) U.S. Cl. CPC G06N 10/40

(57) ABSTRACT

Systems and methods for quantum computing devices are provided. In one example, a method may include implementing, by a quantum computing system, a microwave pulse train in a microwave control signal for a qubit of a quantum computing system, the microwave pulse train having a plurality of microwave pulses. The method may include determining, by the quantum computing system, a Fourier parameter associated with the plurality of microwave pulses based at least in part on a Rabi oscillation of the qubit. The method may include modifying, by the quantum computing system, one or more control signals for the qubit of the quantum computing system based at least in part on the Fourier parameter.

### CROSS-REFERENCE TO RELATED APPLICATIONS

The present application is based upon and claims the right of priority to U.S. Provisional Patent Application No. 63/488,290, filed on Mar. 3, 2023, the disclosure of which (including any appendices) is hereby incorporated by reference herein in its entirety for all purposes.

### FIELD

The present disclosure relates generally to quantum computing systems and more particularly to implementing quantum logic gates using control pulses in quantum computing systems.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems may manipulate information using quantum bits (“qubits”). A qubit may refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0 [symbol] +b|1 [symbol] The “0” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or may be learned from the description, or may be learned through practice of the embodiments.

One example aspect of the present disclosure is directed to a method of implementing one or more control signals on a qubit of a quantum computing system. The method may include implementing, by a quantum computing system, a microwave pulse train in a microwave control signal for a qubit of a quantum computing system, the microwave pulse train having a plurality of microwave pulses. The method may include determining, by the quantum computing system, a Fourier parameter associated with the plurality of microwave pulses based at least in part on a Rabi oscillation of the qubit. The method may include modifying, by the quantum computing system, one or more control signals for the qubit of the quantum computing system based at least in part on the Fourier parameter.

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example quantum computing system according to example embodiments of the present disclosure;

FIG. 2 depicts a flow chart of an example method according to example embodiments of the present disclosure;

FIG. 3 depicts an example pulse train in the time domain and in the Fourier domain according to example embodiments of the present disclosure;

FIG. 4 depicts a flow chart of an example method according to example embodiments of the present disclosure;

FIG. 5 depicts a flow chart of an example method according to example embodiments of the present disclosure;

FIG. 6 depicts a flow chart of an example method according to example embodiments of the present disclosure.

### DETAILED DESCRIPTION

Example aspects of the present disclosure are directed to implementing quantum operations (e.g., quantum logic gates) in a quantum computing system using control pulses. Quantum logic gates may be implemented using control pulses. For instance, quantum logic gates may be implemented using microwave pulses and/or flux pulses. The microwave pulses may be used to control, for instance, qubit rotation to implement, for instance, an X-gate or a Y-gate. A flux bias pulse may be used to control, for instance, a qubit frequency and/or phase.

Qubit control pulses may become distorted in unknown ways during quantum operations, for instance, due to noise or other factors from waveform generators, control lines, junctions, couplings, etc. The control pulses may be non-stable in some instances due to temperature fluctuations and system instabilities. Characterizing control pulses is beneficial to implementing quantum logic gates with high fidelity and to provide for scalable quantum computing systems. Some methods for characterization of control pulses for quantum logic gates are implemented using, for instance, calibration hardware and devices at room temperature that do not account for the low temperatures (e.g., close to zero Kelvin) at which quantum computing systems may operate (e.g., quantum computing systems having superconducting qubits).

Aspects of the present disclosure are directed to systems and methods that use the one or more qubits of the quantum computing system as a probe to estimate control pulse distortion. In particular aspects, the examples of the present disclosure may coherently amplify control signals with pulse trains. The pulse trains may include a sequence of pulses with fixed phase shifts between the pulses. To measure the Fourier amplitudes of the microwave control pulses, the qubit may be prepared in a state close to the target frequency to be characterized. By tuning the phase shift, Rabi oscillations are introduced for the qubits. The Fourier amplitude may be estimated based at least in part on a frequency of the Rabi oscillations.

To estimate the phase difference between two frequency components of the microwave pulse, an oscillatory flux pulse may be applied in addition to the microwave pulse train. By matching the period of the flux pulse and the frequency difference of two microwave frequency components, parametric amplification may be achieved. The process converts a relative phase between the two microwave frequency components into an amplitude of the Rabi angle, which can be estimated based at least in part on the frequency of the Rabi oscillation.

After the microwave control pulses are calibrated, the flux pulse distortion may be estimated. More particularly, a monochromatic microwave pulse may be applied in addition to a flux pulse train. By measuring the Rabi angle, information about the Fourier transformation of the exponential of the flux pulse may be obtained.

The characterization of pulse distortion may be used to compensate for pulse distortion in providing future control signals to implement quantum logic gates in the quantum computing system. For instance, the control signals may be pre-distorted to compensate for the pulse distortion.

Aspects of the present disclosure provide a number of technical effects and benefits. For instance, aspects of the present disclosure may allow for the characterization of control pulses at the operating temperature (e.g., close to zero Kelvin) of the qubits without having to disconnect the control lines providing the control pulses to the qubits. Aspects of the present disclosure may provide for characterization of a full transfer function for a quantum operation and account for pulse distortions (e.g., by pre-distorting the pulses). This may lead to more accurate characterization of control pulses and determination of potential distortion. This can be used to reduce errors in the quantum computing system, leading to increased coherency and scalability of the quantum computing system.

In addition, aspects of the present disclosure may be used to obtain information regarding phase and amplitude of microwave pulse distortions as well as amplitude of flux pulse distortions. The characterization of the control pulse distortions may be obtained without linear transfer functions at high precision (e.g., at the Heisenberg limit). The aspects of the present disclosure are robust to state preparation and measurement (SPAM) errors. The control pulse distortions may be characterized without knowledge of the exact flux-frequency function. Resolution of the flux pulses is not affected by the finite width of the microwave pulses. Aspects of the present disclosure do not require specific assumptions on specific forms of the control pulse distortions (e.g., 90° phase shifted reflections). Moreover, aspects of the present disclosure do not require monotonic flux pulses to characterize the microwave pulse distortion.

Aspects of the present disclosure may be used in a variety of applications and/or to characterize a variety of pulse distortions (e.g., reflections, crosstalk, timing or synchronization errors, amplitude distortions, phase distortions, etc.). For example, some embodiments according to examples of the present disclosure can be used to diagnose reflections in various circuits, including circuits spanning one or more temperature gradients (e.g., first component in a 3-Kelvin environment in communication with second component in a 300-Kelvin environment and/or third component in a 30 milli-Kelvin environment). Some embodiments according to examples of the present disclosure can be used to determine one or more pulse shapes with 0.01-nanosecond timing precision, which can in some instances be used for pulse synchronization with sub-nanosecond precision. Some embodiments according to examples of the present disclosure can be used for crosstalk compensation in any circuit context, in contrast to alternative parameter-based methods which may only provide crosstalk compensation in fixed circuit contexts. In some example experiments, pre-distorting input pulses according to aspects of the present disclosure provided a desired pulse shape with 99 percent accuracy, with no additional calibrations needed. Additionally, aspects of the present disclosure can be used to enable faster quantum gates to combat T1 and T2 errors, while keeping leakage low.

As used herein, the use of the term “about” or “approximately” in conjunction with a stated numerical value is intended to refer to within 10% of the stated numerical value. As used herein, “near maximum” refers to within 10% of a maximum. As used herein, “near minimum” refers to within 10% of a minimum.

With reference now to the FIGS., example embodiments of the present disclosure will be discussed in further detail.

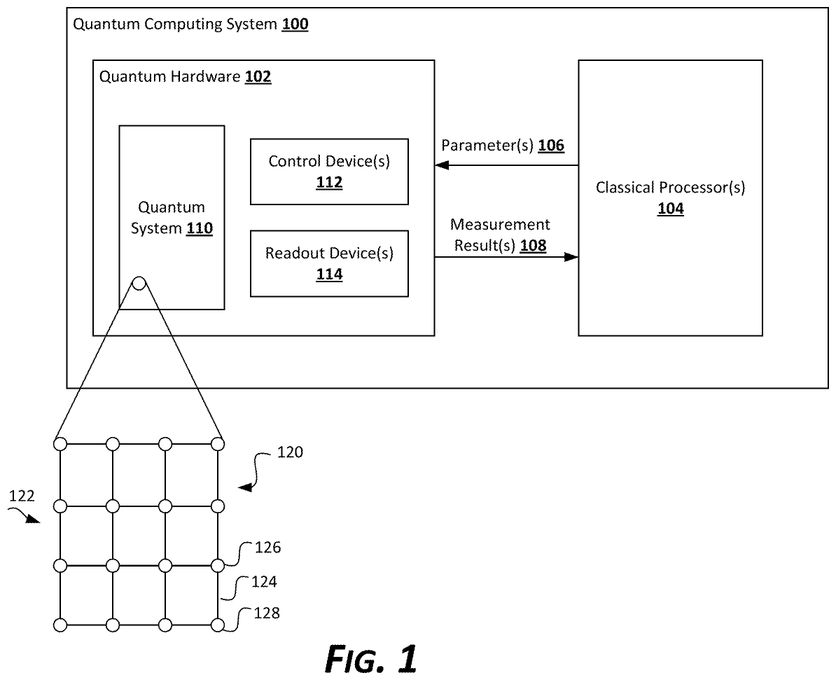

FIG. 1 depicts an example quantum computing system 100. The system 100 is an example of a system of one or more classical computers and/or quantum computing devices in one or more locations, in which the systems, components, and techniques described below may be implemented. Those of ordinary skill in the art, using the disclosures provided herein, will understand that other quantum computing devices or systems may be used without deviating from the scope of the present disclosure.

The system 100 includes quantum hardware 102 in data communication with one or more classical processors 104. The classical processors 104 may be configured to execute computer-readable instructions stored in one or more memory devices to perform operations, such as any of the operations described herein. The quantum hardware 102 includes components for performing quantum computation. For example, the quantum hardware 102 includes a quantum system 110, control device(s) 112, and readout device(s) 114 (e.g., readout resonator(s)). The quantum system 110 may include one or more multi-level quantum subsystems, such as a register of qubits (e.g., qubits 120). In some implementations, the multi-level quantum subsystems may include superconducting qubits, such as flux qubits, charge qubits, transmon qubits, gmon qubits, etc.

The type of multi-level quantum subsystems that the system 100 utilizes may vary. For example, in some cases it may be convenient to include one or more readout device(s) 114 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots or phosphorus impurity qubits.

Quantum circuits may be constructed and applied to the register of qubits included in the quantum system 110 via multiple control lines that are coupled to one or more control devices 112. Example control devices 112 that operate on the register of qubits may be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to adjust the frequency of the qubits.

The quantum hardware 102 may further include readout devices 114 (e.g., readout resonators). Measurement results 108 obtained via measurement devices may be provided to the classical processors 104 for processing and analyzing. In some implementations, the quantum hardware 102 may include a quantum circuit and the control device(s) 112 and readout devices(s) 114 may implement one or more quantum logic gates that operate on the quantum system 102 through physical control parameters (e.g., microwave pulses) that are sent through wires included in the quantum hardware 102. Further examples of control devices include arbitrary waveform generators, wherein a DAC (digital to analog converter) creates the signal.

The readout device(s) 114 may be configured to perform quantum measurements on the quantum system 110 and send measurement results 108 to the classical processors 104. In addition, the quantum hardware 102 may be configured to receive data specifying physical control qubit parameter values 106 from the classical processors 104. The quantum hardware 102 may use the received physical control qubit parameter values 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of parameters 106.

In some implementations, the readout device(s) 114 may take advantage of a difference in the impedance for the |0 [symbol] and |1 [symbol] states of an element of the quantum system, such as a qubit, to measure the state of the element (e.g., the qubit). For example, the resonance frequency of a readout resonator may take on different values when a qubit is in the state |0 [symbol] or the state |1 [symbol] , due to the nonlinearity of the qubit. Therefore, a microwave pulse reflected from the readout device 114 carries an amplitude and phase shift that depend on the qubit state. In some implementations, a Purcell filter may be used in conjunction with the readout device(s) 114 to impede microwave propagation at the qubit frequency.

In some embodiments, the quantum system 110 may include a plurality of qubits 120 arranged, for instance, in a two-dimensional grid 122. For clarity, the two-dimensional grid 122 depicted in FIG. 1 includes 4×4 qubits, however in some implementations the system 110 may include a smaller or a larger number of qubits. In some embodiments, the multiple qubits 120 may interact with each other through multiple qubit couplers, e.g., qubit coupler 124. The qubit couplers may define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, the multiple qubits 120 may include data qubits, such as qubit 126 and measurement qubits, such as qubit 128. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 120 may be operated using respective operating frequencies, such as an idling frequency and/or an interaction frequency(s) and/or readout frequency and/or reset frequency. The operating frequencies may vary from qubit to qubit. For instance, each qubit may idle at a different operating frequency. The operating frequencies for the qubits 120 may be chosen before a computation is performed.

FIG. 1 depicts one example quantum computing system that may be used to implement the methods and operations according to example aspects of the present disclosure. Other quantum computing systems may be used without deviating from the scope of the present disclosure.

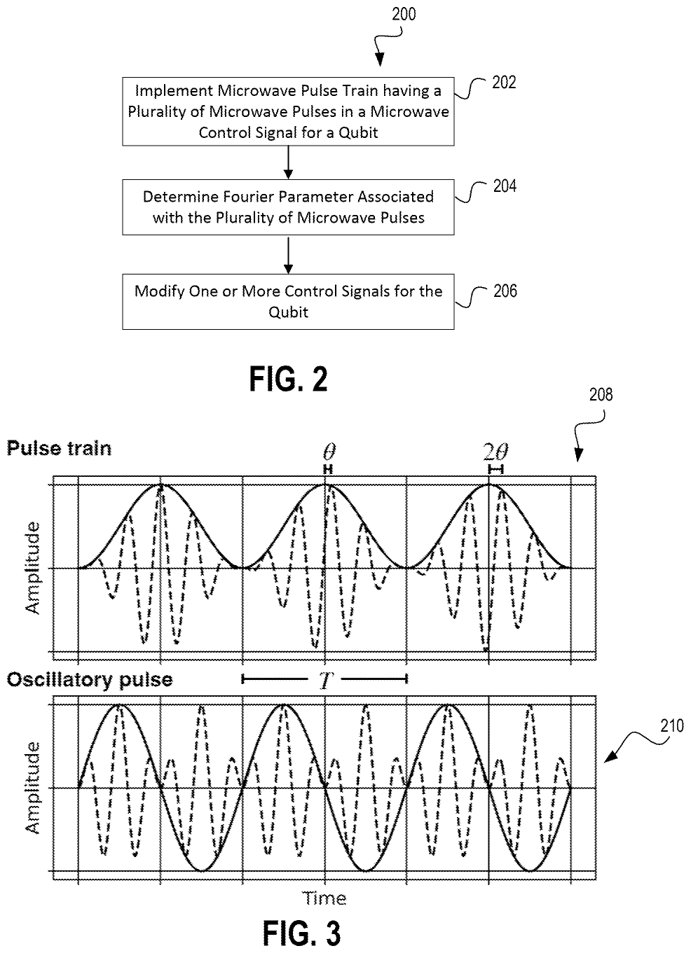

FIG. 2 depicts a flow diagram of an example method according to example embodiments of the present disclosure. The method 200 may be implemented using any suitable classical and/or quantum computing system, such as the quantum computing system 100 of FIG. 1. FIG. 2 depicts operations performed in a particular order for purposes of illustration and discussion. Those of ordinary skill in the art, using the disclosures provided herein, will understand that the operations of any of the methods described herein may be rearranged, adapted, expanded, include steps not illustrated, and/or modified in various ways without deviating from the scope of the present disclosure.

At 202, the method 200 includes implementing a microwave pulse train (e.g., using signal generation hardware) having a plurality of microwave pulses in a microwave control signal for a qubit of a quantum computing system. The qubit may be a superconducting qubit. The superconducting qubit may be associated with an operating temperature of, for instance, less than about 1 Kelvin. In some instances, a microwave pulse can be single-tone (e.g., for estimating a Fourier amplitude) or double-tone (e.g., for estimating a phase difference between Fourier components). In some instances, a microwave pulse can include a cosine envelope function. In some instances, a frequency of the qubit can be configured (e.g., via a constant or approximately constant flux bias) to be equal to or approximately equal to a frequency of interest (e.g., target frequency to be characterized; frequency associated with a microwave pulse of interest, Fourier component of interest, etc.). In some instances, method 200 at 202 can include calibrating a drive frequency of the microwave pulse train to be on resonance with the qubit.

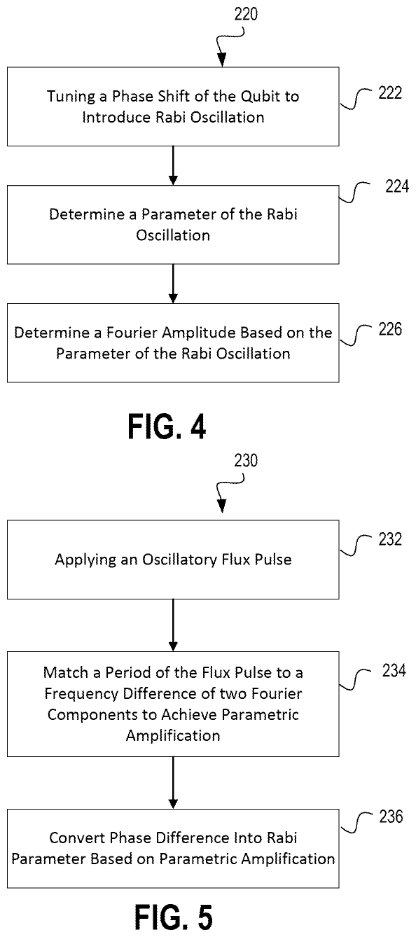

FIG. 3 depicts an example microwave pulse train 208 in the time domain. As shown, the microwave pulse train can have a period T and can implement a fixed phase shift θ between consecutive pulses of the plurality of microwave pulses. In the frequency domain, different Fourier components (e.g., frequency components) of the microwave pulse train 208 may have a Fourier parameter, such as a Fourier amplitude and phase difference between frequency components. These Fourier components may be indicative of control signal distortions in the microwave control signal. FIG. 3 also depicts an example oscillatory pulse 210 for determining a phase difference between Fourier components (e.g., using example methods described with respect to FIG. 4). In some instances, an oscillatory pulse 210 can have a period T that is similar to (e.g., same as) a period T of a microwave pulse train 208.

At 204 of FIG. 2, the method 200 includes determining a Fourier parameter (e.g., Fourier amplitude and/or phase difference between Fourier components) associated with the microwave control signal including the plurality of microwave pulses of the microwave pulse train. Details concerning example methods of determining Fourier amplitude are discussed with reference to FIG. 4. Details concerning example methods of determining phase difference between Fourier components are discussed with reference to FIG. 5.

At 206 of FIG. 2, the method 200 includes modifying one or more control signals for the qubit based at least in part on the Fourier parameter. The Fourier parameter may be indicative of aspects of the microwave control signal distortion. Once determined, the Fourier parameter may be used to determine modifications for future microwave control signals to compensate for the control signal distortions such that errors in implementing quantum logic gates using the microwave control signal are reduced. This increases coherency of the quantum computing system.

FIG. 4 depicts a flow diagram of an example method 220 of determining Fourier amplitude associated with the plurality of microwave pulses according to example embodiments of the present disclosure. The method 220 may be implemented using any suitable classical and/or quantum computing system, such as the quantum computing system 100 of FIG. 1. FIG. 4 depicts operations performed in a particular order for purposes of illustration and discussion. Those of ordinary skill in the art, using the disclosures provided herein, will understand that the operations of any of the methods described herein may be rearranged, adapted, expanded, include steps not illustrated, and/or modified in various ways without deviating from the scope of the present disclosure.

At 222, the method 220 may include tuning a phase shift of the qubit to introduce Rabi oscillation(s) for the qubit(s) in the quantum computing system. At 222, in some instances, a phase increment of the microwave pulse train can be configured to minimize an off-resonant phase associated with the pulse train. For example, in some instances, control of a qubit frequency may be insufficiently precise to completely eliminate off-resonant Rabi oscillations. In such instances, a number k (e.g., about 10, about 20, about 40, etc.) of cycles (e.g., consecutive pulses) associated with a microwave pulse train can be selected, and a plurality of candidate phase increments can be tested to find a resonance point. In some instances, a single phase increment may be selected, such as when a remaining off-resonance associated with the selected phase increment is small (e.g., orders of magnitude smaller than a Fourier amplitude of a Fourier component of interest). In other instances, two or more (e.g., two) phase increments may be selected, such as when a remaining off-resonance associated with each candidate phase increment is of the same order of magnitude as the Fourier amplitude of a Fourier component of interest.

At 224, a parameter of the Rabi oscillation(s) may be determined, for instance, by performing experiments (e.g., measurements) of the qubit(s). The parameter of the Rabi oscillation may be the Rabi angle. In some instances, a cycle Rabi angle r can be estimated by fitting a plurality of measurements to a unitary transformation associated with the microwave pulse train. For example, in a microwave pulse train having k cycles and a very small off-resonant phase (e.g., orders of magnitude smaller than a Fourier amplitude) or an off-resonant phase very close to a multiple of 2π (e.g. off-resonant phase modulo 2π is orders of magnitude smaller than a Fourier amplitude), a unitary transformation associated with the k-cycle pulse train can be:

$$\frac{\vert sin ( k r ) \overline{{f}_{θ}} ( Δ ) \vert}{r} ,$$

where r is a cycle Rabi angle (e.g., Rabi angle associated with a single cycle, such as a single pulse of a microwave pulse train), and \tilde{f}_{θ}(Δ) is a Fourier transformation of the microwave pulse train. In some instances, r can be written as:

$$r = \sqrt{{\vert \overline{{f}_{θ}} ( Δ ) \vert}^{2} + \frac{{\hat{ϕ}}^{2}}{4}} ,$$

where |\tilde{f}_{θ}(Δ)| is a Fourier amplitude, and \hat{ϕ} is an off-resonant phase modulo 2π.

At 226, the Fourier amplitude may be determined based on the parameter of the Rabi oscillation. For example, in instances where an off-resonant phase modulo 2π is close to zero (e.g., equal to zero; orders of magnitude smaller than Fourier amplitude; etc.), a cycle Rabi angle r can be close to (e.g., equal to) a Fourier amplitude of interest, and can be easily estimated by fitting one or more (e.g., a plurality of) measurements to the above equation describing the k-cycle unitary transformation. For example, in some instances, a probability of measuring the qubit in the basis state |1 [symbol] can be equal to the square of the unitary transformation function described above. In some instances, fitting a plurality of measurements to determine a Fourier parameter can include fitting using a density matrix simulation. In instances where an off-resonant phase modulo 2π is not close to zero, two or more (e.g., two) cycle Rabi angles r can be estimated for two or more (e.g., two) phase increment values, and an off-resonant phase and Fourier amplitude can be determined precisely based on the two or more cycle Rabi angles r. In some instances (e.g. when a phase increment and period of the pulse train can be controlled precisely), an off-resonant phase ϕ (or off-resonant phase modulo 2π, \hat{ϕ}) and a detuning A (e.g., detuning of a microwave drive from a qubit frequency) can be determined based on a phase increment θ and a period T of the pulse train, based on the equation ϕ=ΔT−θ.

FIG. 5 depicts a flow diagram of 230 of determining a phase difference between Fourier components associated with the plurality of microwave pulses according to example embodiments of the present disclosure. The method 230 may be implemented using any suitable classical and/or quantum computing system, such as the quantum computing system 100 of FIG. 1. FIG. 5 depicts operations performed in a particular order for purposes of illustration and discussion. Those of ordinary skill in the art, using the disclosures provided herein, will understand that the operations of any of the methods described herein may be rearranged, adapted, expanded, include steps not illustrated, and/or modified in various ways without deviating from the scope of the present disclosure.

At 232, the method 230 includes applying an oscillatory flux pulse (e.g., oscillatory pulse 210, etc.) in conjunction with the microwave control signal (e.g., with microwave pulse train). However, in some instances, an oscillatory flux pulse may not be required. For example, in some instances, method 230 at 232 can include applying instantaneous Z gates at times t=T/2 and t=T, where T is a period of the microwave pulse train. In this manner, for instance, these π gates can serve as a time reference for the microwave gates, thereby providing a fixed time frame for estimation of a relative phase of two Fourier components.

At 234, the method may include tuning the flux pulse to match a period of the flux pulse with a frequency difference of two Fourier components to achieve parametric amplification. In some instances, a parametric amplification can be configured to map a phase difference (e.g., phase difference between a microwave pulse and a flux pulse) to a Rabi angle that can be amplified. In some instances, the Rabi angle can be proportional to a sine of the phase difference. In some instances, method 230 at 234 can include sweeping over a Z-channel phase (e.g., oscillatory flux pulse phase). In some instances, a plurality of flux pulse phases can be tested, and measurements associated with the plurality of flux pulse phases can be fit to a sinusoid. In some instances, tuning a flux pulse can include configuring a parameter of the flux pulse to maximize a value of a Bessel function (e.g., first-order Bessel function). In some instances, tuning a flux pulse can include adjusting an amplitude of the oscillatory flux pulse (e.g., to amplify a Rabi angle, to maximize or otherwise increase a value of a Bessel function, etc.). At 236, the method may include converting the phase difference into a Rabi parameter based on the parametric amplification. Similar to the Fourier amplitude, the Rabi parameter may be determined by performing experiments (e.g., measurements) of the qubit(s). The phase difference may be determined based at least in part on the Rabi parameter.

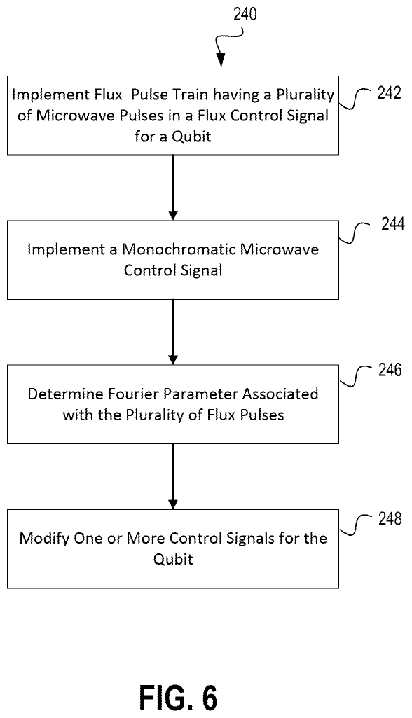

Aspects of the present disclosure are also directed to determining flux distortions in flux control signals for qubit(s) in a quantum computing system. FIG. 6 depicts a flow diagram of an example method 240 for implementing control signals based on characterization of such flux distortions according to example embodiments of the present disclosure. The method 240 may be implemented using any suitable classical and/or quantum computing system, such as the quantum computing system 100 of FIG. 1. FIG. 6 depicts operations performed in a particular order for purposes of illustration and discussion. Those of ordinary skill in the art, using the disclosures provided herein, will understand that the operations of any of the methods described herein may be rearranged, adapted, expanded, include steps not illustrated, and/or modified in various ways without deviating from the scope of the present disclosure.

At 242, the method 240 includes implementing a flux pulse train (e.g., using signal generation hardware) having a plurality of flux pulses in a flux control signal for a qubit of a quantum computing system. The qubit may be a superconducting qubit. The superconducting qubit may be associated with an operating temperature of, for instance, less than about 1 Kelvin.

At 244, the method 240 may include implementing a monochromatic (e.g., monofrequency) microwave control signal in conjunction with the flux control signal having the flux pulse train.

At 246, the method 246 includes determining a Fourier parameter (e.g., Fourier amplitude) associated with the flux control signal including the plurality of flux pulses of the flux pulse train.

At 248 of FIG. 2, the method 240 includes modifying one or more control signals for the qubit based at least in part on the Fourier parameter. The Fourier parameter may be indicative of aspects of the flux control signal distortion. Once determined, the Fourier parameter may be used to determine modifications for future flux control signals to compensate for the control signal distortions such that errors in implementing quantum logic gates using the flux control signal are reduced. This increases coherency of the quantum computing system.

Implementations of the digital and/or quantum subject matter and the digital functional operations and quantum operations described in this specification may be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification may be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium may be a machine-readable storage device, a machine-readable storage substrate, a random or serial access memory device, one or more qubits/qubit structures, or a combination of one or more of them. Alternatively or in addition, the program instructions may be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems may include atoms, electrons, photons, ions or superconducting qubits. In many implementations the computational basis states are identified with the ground and first excited states, however it is understood that other setups where the computational states are identified with higher level excited states (e.g., qudits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus may also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus may optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, may be written in any form of programming language, including compiled or interpreted languages, or declarative or procedural languages, and it may be deployed in any form, including as a stand-alone program or as a module, component, subroutine, or other unit suitable for use in a digital computing environment. A quantum computer program, which may also be referred to or described as a program, software, a software application, a module, a software module, a script, or code, may be written in any form of programming language, including compiled or interpreted languages, or declarative or procedural languages, and translated into a suitable quantum programming language, or may be written in a quantum programming language, e.g., QCL, Quipper, Cirq, etc..

A digital and/or quantum computer program may, but need not, correspond to a file in a file system. A program may be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program may be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification may be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows may also be performed by, and apparatus may also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program may be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory may be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that may store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, may be implemented in a digital and/or quantum computer program product that includes instructions that are stored on one or more non-transitory machine-readable storage media, and that are executable on one or more digital and/or quantum processing devices. The systems described in this specification, or portions of them, may each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations may also be implemented in combination in a single implementation. Conversely, various features that are described in the context of a single implementation may also be implemented in multiple implementations separately or in any suitable sub combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems may generally be integrated together in a single software product or packaged into multiple software products.

Particular implementations of the subject matter have been described. Other implementations are within the scope of the following claims. For example, the actions recited in the claims may be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of implementing one or more control signals on a qubit of a quantum computing system, comprises:
implementing, by a quantum computing system, a microwave pulse train in a microwave control signal for a qubit of a quantum computing system, the microwave pulse train having a plurality of microwave pulses;
determining, by the quantum computing system, a Fourier parameter associated with the plurality of microwave pulses based at least in part on a Rabi oscillation of the qubit; and
modifying, by the quantum computing system, one or more control signals for the qubit of the quantum computing system based at least in part on the Fourier parameter.

2. The method of claim 1, wherein the microwave pulse train implements a fixed phase shift between consecutive pulses of the plurality of microwave pulses.

3. The method of claim 1, wherein the Fourier parameter comprises a Fourier amplitude of one or more of the plurality of microwave pulses.

4. The method of claim 3, wherein determining, by the quantum computing system, the Fourier parameter associated with the plurality of microwave pulses based at least in part on a Rabi oscillation of the qubit comprises:
tuning, by the quantum computing system, a phase shift of the qubit to introduce the Rabi oscillation;
determining, by the quantum computing system, a parameter of the Rabi oscillation; and
determining, by the quantum computing system, the Fourier amplitude based at least in part on the parameter of the Rabi oscillation.

5. The method of claim 4, wherein the parameter of the Rabi oscillation comprises a Rabi angle.

6. The method of claim 1, wherein the Fourier parameter comprises a phase difference between two Fourier components of the microwave control signal during implementing of the microwave pulse train.

7. The method of claim 6, wherein determining the Fourier parameter comprises:
applying, by the quantum computing system, an oscillatory flux pulse; and
matching, by the quantum computing system, a period of the flux pulse to a frequency difference of the two Fourier components to achieve parametric amplification.

8. The method of claim 7, wherein the parametric amplification converts the phase difference into Rabi parameter.

9. The method of claim 8, wherein the Rabi parameter comprises an amplitude of the Rabi angle of the Rabi oscillation.

10. The method of claim 1, further comprising:
implementing, by the quantum computing system, a flux pulse train in a flux control signal for a qubit of a quantum computing system, the flux pulse train having a plurality of flux pulses;
determining, by the quantum computing system, a Fourier parameter associated with the plurality of flux pulses based at least in part on a Rabi oscillation of the qubit;
modifying, by the quantum computing system, one or more control signals for the qubit of the quantum computing system based at least in part on the Fourier parameter.

11. The method of claim 10, wherein the method comprises implementing, by the quantum computing system, a monochromatic microwave pulse signal during the flux pulse train.

12. The method of claim 1, wherein the qubit comprises a superconducting qubit.

13. The method of claim 12, wherein the superconducting qubit is at an operating temperature of less than about 1 Kelvin.

14. A quantum computing system, comprising:
a superconducting qubit; and
a control system operable to provide one or more control signal to implement quantum logic gates on the superconducting qubit;
wherein the quantum computing system is configured to perform operations, the operations comprising:
implementing a microwave pulse train in a microwave control signal for a qubit of a quantum computing system, the microwave pulse train having a plurality of microwave pulses;
determining a Fourier parameter associated with the plurality of microwave pulses based at least in part on a Rabi oscillation of the qubit; and
modifying one or more control signals for the qubit of the quantum computing system based at least in part on the Fourier parameter.

15. The quantum computing system of claim 14, wherein the Fourier parameter comprises a Fourier amplitude of one or more of the plurality of microwave pulses.

16. The quantum computing system of claim 15, wherein the operation of determining the Fourier parameter associated with the plurality of microwave pulses based at least in part on a Rabi oscillation of the qubit comprises:
tuning a phase shift of the qubit to introduce the Rabi oscillation;
determining a parameter of the Rabi oscillation; and
determining the Fourier amplitude based at least in part on the parameter of the Rabi oscillation.

17. The quantum computing system of claim 14, wherein the Fourier parameter comprises a phase difference between two Fourier components of the microwave control signal during implementing of the microwave pulse train.

18. The quantum computing system of claim 17, wherein the operation of determining the Fourier parameter comprises:
applying an oscillatory flux pulse; and
matching a period of the flux pulse to a frequency difference of the two Fourier components to achieve parametric amplification.

19. A tangible non-transitory computer-readable medium storing computer-readable instructions that when executed by one or more classical or quantum processors cause the one or more classical or quantum processors to perform operations, the operations comprising:
implementing a flux pulse train in a flux control signal for a qubit of a quantum computing system, the flux pulse train having a plurality of flux pulses;
determining a Fourier parameter associated with the plurality of flux pulses based at least in part on a Rabi oscillation of the qubit; and
modifying one or more control signals for the qubit of the quantum computing system based at least in part on the Fourier parameter.

20. The tangible non-transitory computer-readable medium of claim 19, wherein the operations comprise implementing a monochromatic microwave pulse signal during the flux pulse train.
